(19) United States
(12) Patent Application Publication
(10) Pub. No.: US 2024/0122426 A1
(43) Pub. Date: Apr. 18, 2024

(54) CLEANING DEVICE

(71) Applicant: Guangzhou Fengxue Technology Co., Ltd., Guangzhou (CN)

(72) Inventor: Hong Zhou, Guangzhou (CN)

(21) Appl. No.: 18/396,757

(22) Filed: Dec. 27, 2023

(30) Foreign Application Priority Data
Dec. 18, 2023 (CN) 202323465597.0

(51) Int. Cl. A47L 9/14; A47L 9/24

(52) U.S. Cl. CPC A47L 9/1427; A47L 9/242; A47L 9/248

(57) ABSTRACT

The present disclosure provides a cleaning device, including a connecting bag, a supporting portion, a middle portion, and an extending portion. By the connecting bag, the product can be combined for use with various different kinds of air blowers. The supporting portion is arranged inside the connecting bag to avoid the connecting bag from being curled to affect smooth passing of an air flow. In addition, by extension of the extending portion, the cleaning device can adapt to different working environments, so as to well clean an eave.

### CROSS-REFERENCE TO RELATED APPLICATIONS

The application claims priority of Chinese patent application CN 2023234655970, filed on Dec. 18, 2023, which is incorporated herein by reference in its entireties.

### TECHNICAL FIELD

The present disclosure relates to the field of cleaning devices, and in particular to a cleaning device.

### BACKGROUND

Although existing products have flexible connecting bags, if a user holds an air blower in one hand and holds the product in the other hand during use, the connecting bag will be blocked, which affects passing of an air flow.

### SUMMARY

In order to overcome the shortcomings of the prior art, the present disclosure provides a cleaning device, including:
a connecting bag, wherein the connecting bag includes a first opening and a second opening, and the first opening is communicated to the second opening; and
a supporting portion, wherein the supporting portion is connected to the connecting bag to support the connecting bag.

As the improvement of the present disclosure, the supporting portion is an elastic supporting portion, and the connecting bag is a flexible connecting bag.

As the improvement of the present disclosure, a radius of the first opening is less than a radius of the second opening; the supporting portion is connected to the first opening; and the second opening is configured to be connected to a blowing and suction device.

As the improvement of the present disclosure, the connecting bag includes a bag part and a locking part; the locking part is connected to the bag part; and the locking part is configured to connect the bag part to the blowing and suction device.

As the improvement of the present disclosure, the locking part includes a ring band; one side of the bag part is provided with several first connecting portions; and the ring band passes through the first connecting portions and is fixed to the bag part.

As the improvement of the present disclosure, the locking part further includes an elastic adjustment buckle; the ring band is connected to the elastic adjustment buckle; the ring band is arranged around the second opening; and the elastic adjustment buckle is configured to adjust a size of the second opening.

As the improvement of the present disclosure, the cleaning device further includes a middle portion, wherein the middle portion is provided with a second connecting portion; the supporting portion is provided with a third connecting portion; and the second connecting portion is detachably connected to the third connecting portion to detachably connect the middle portion to the supporting portion.

As the improvement of the present disclosure, the second connecting portion is rotatably connected to the third connecting portion.

As the improvement of the present disclosure, the third connecting portion is a convex point; the second connecting portion is provided with a sliding chute and a rotating groove; and the convex point enters the rotating groove from the sliding chute to enable the convex point to rotate inside the rotating groove, so that the middle portion rotates relative to the supporting portion.

As the improvement of the present disclosure, a tie is arranged at the first opening; the supporting portion is provided with a clamping slot; the supporting portion passes through the second opening and the first opening in sequence; and the tie is tightly tied inside the clamping slot to connect the connecting bag to the supporting portion.

As the improvement of the present disclosure, the cleaning device further includes an extending portion, wherein the extending portion is detachably connected to the middle portion.

As the improvement of the present disclosure, the extending portion includes a middle pipe and a first air pipe; the middle pipe is detachably connected to the first air pipe; and the middle pipe is detachably connected to the middle portion.

As the improvement of the present disclosure, the middle pipe includes several detachable connecting pipes, and the several detachable connecting pipes are detachably connected to each other to form a whole.

As the improvement of the present disclosure, the middle pipe at least includes a first connecting pipe, a second connecting pipe, and a third connecting pipe.

As the improvement of the present disclosure, one end of the middle portion is provided with a fourth connecting portion; one end of the first connecting pipe is provided with a fifth connecting portion; the fourth connecting portion is detachably connected to the fifth connecting portion to detachably connect the middle portion to the first connecting pipe; the other end of the first connecting pipe is provided with a sixth connecting portion; one end of the second connecting pipe is provided with a seventh connecting portion; the sixth connecting portion is detachably connected to the seventh connecting portion to detachably connect the first connecting pipe to the second connecting pipe; the other end of the second connecting pipe is provided with an eighth connecting portion, and one end of the third connecting pipe is provided with a ninth connecting portion; the eighth connecting portion is detachably connected to the ninth connecting portion to detachably connect the second connecting pipe to the third connecting pipe; the other end of the third connecting pipe is provided with a tenth connecting portion, and one end of the first air pipe is provided with an eleventh connecting portion; and the tenth connecting portion is detachably connected to the eleventh connecting portion to detachably connect the third connecting pipe to the first air pipe.

As the improvement of the present disclosure, the fourth connecting portion, the sixth connecting portion, the eighth connecting portion, and the tenth connecting portion are internal threads, and the fifth connecting portion, the seventh connecting portion, the ninth connecting portion, and the eleventh connecting portion are external threads.

As the improvement of the present disclosure, the supporting portion includes several supporting claws; each of the supporting claws includes an outer surface and an inner surface opposite to the outer surface; and the supporting claws are connected to the connecting bag through the outer surface to support the connecting bag.

As the improvement of the present disclosure, a protective layer is arranged inside the connecting bag, and the protective layer is configured to cover the inner surface.

As the improvement of the present disclosure, the other end of the first air pipe is provided with a first air port.

As the improvement of the present disclosure, the first air pipe is designed in an angle with the middle pipe.

As the improvement of the present disclosure, the first air pipe and the middle pipe are coaxially arranged.

As the improvement of the present disclosure, several antiskid lines are uniformly distributed on side walls of the middle portion and the middle pipe.

Beneficial effects of the present disclosure are as follows: The present disclosure provides a cleaning device, including a connecting bag, a supporting portion, a middle portion, and an extending portion. By the connecting bag, the product can be combined for use with various different kinds of air blowers. The supporting portion is arranged inside the connecting bag to avoid the connecting bag from being curled to affect smooth passing of an air flow. In addition, by extension of the extending portion, the cleaning device can adapt to different working environments, so as to well clean an eave.

### BRIEF DESCRIPTION OF THE DRAWINGS

In order to explain the technical solutions of the embodiments of the present disclosure more clearly, the following will briefly introduce the accompanying drawings used in the embodiments. The drawings in the following description are only some embodiments of the present disclosure. Those of ordinary skill in the art can obtain other drawings based on these drawings without creative work.

The present disclosure is further described below in detail in combination with the accompanying drawings and embodiments.

FIG. 1 is a front view of a cleaning device according to the present disclosure;

FIG. 2 is an exploded view of a cleaning device according to the present disclosure;

FIG. 3 is a partial view of a middle portion according to the present disclosure;

FIG. 4 is a partial view of a connecting bag according to the present disclosure;

FIG. 5 is sectional view along a first air pipe according to the present disclosure;

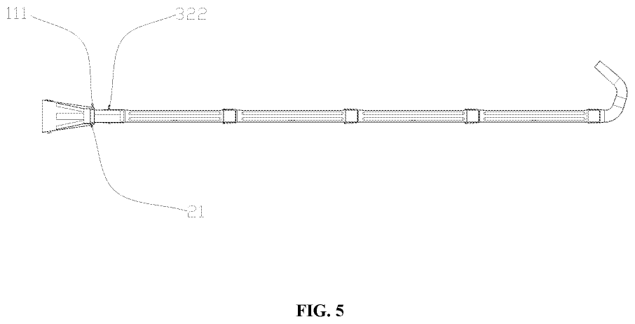

FIG. 6 is a schematic diagram of an entire structure of the present disclosure; and

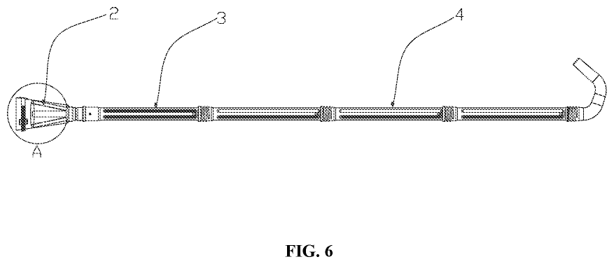

FIG. 7 is a partially enlarged view of part A in FIG. 6 according to the present disclosure.

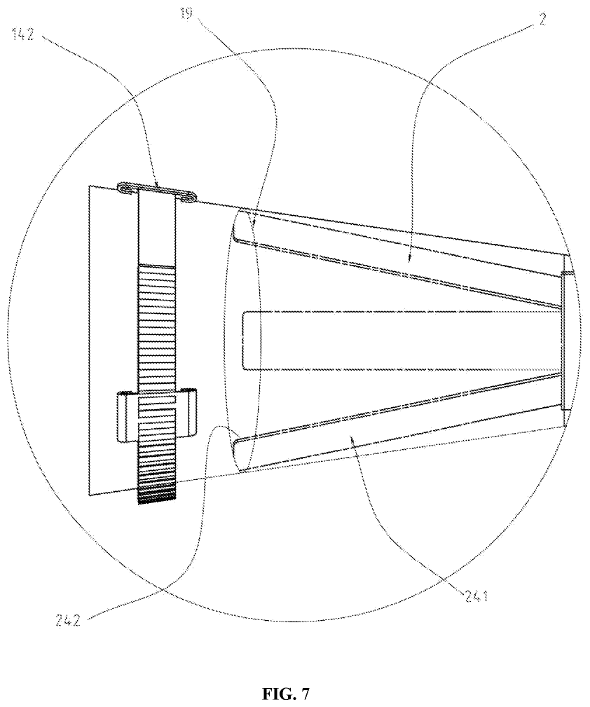

### DETAILED DESCRIPTION OF THE EMBODIMENTS

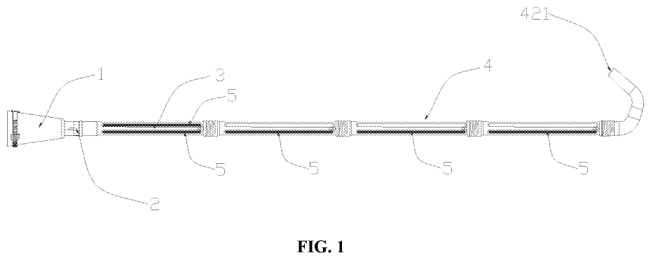

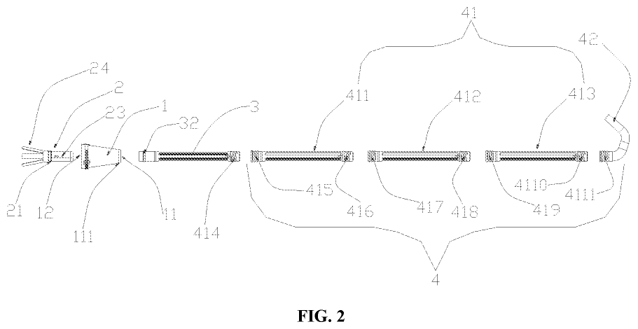

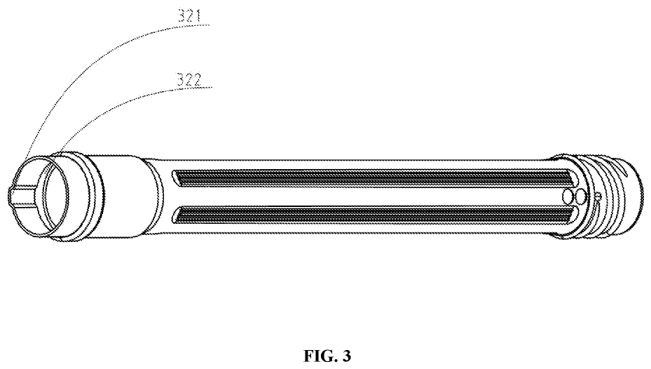

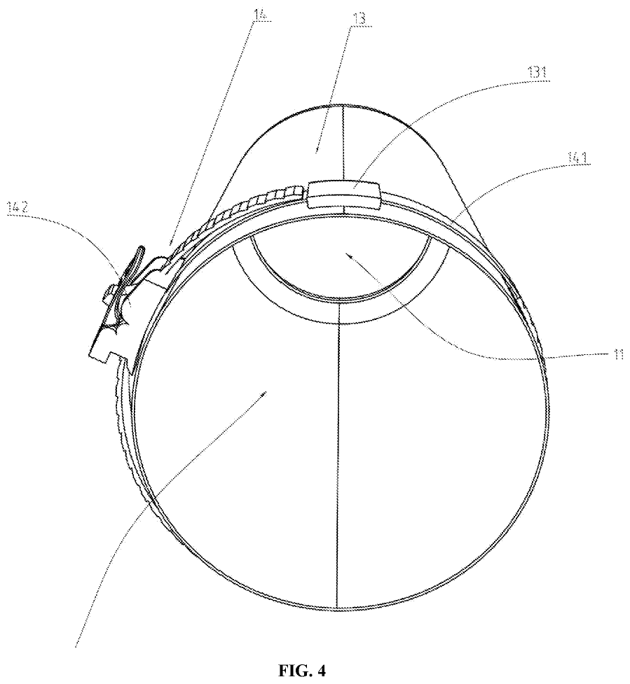

Referring to FIG. 1 to FIG. 4, a cleaning device includes:
a connecting bag 1, wherein the connecting bag 1 includes a first opening 11 and a second opening 12, and the first opening 11 is communicated to the second opening 12; and
a supporting portion 2, wherein the supporting portion 2 is connected to the connecting bag 1 to support the connecting bag 1. The supporting portion 2 is an elastic supporting portion 2, and the connecting bag 1 is a flexible connecting bag 1. Through the design of the elastic supporting portion 2, such a phenomenon can be avoided: If a user holds an air blower in one hand and holds the product in the other hand during use, the connecting bag 1 will be blocked.

In this embodiment, a radius of the first opening 11 is less than a radius of the second opening 12; the supporting portion 2 is connected to the first opening 11; and the second opening 12 is configured to be connected to a blowing and suction device. The entire connecting bag 1 is conical, and the large second opening 12 facilitates adapting to various types of air blowers.

In this embodiment, the connecting bag 1 includes a bag part 13 and a locking part 14; the locking part 14 is connected to the bag part 13; and the locking part 14 is configured to connect the bag part 13 to the blowing and suction device. The locking part 14 includes a ring band 141; one side of the bag part 13 is provided with several first connecting portions 131; and the ring band 141 passes through the first connecting portions 131 and is fixed to the bag part 13. The locking part 14 further includes an elastic adjustment buckle 142; the ring band 141 is connected to the elastic adjustment buckle 142; the ring band 141 is arranged around the second opening 12; and the elastic adjustment buckle 142 is configured to adjust a size of the second opening 12. The second opening 12 is fixed at a first air port of teh air blower through the elastic adjustment buckle 142, so that an air flow passes through the cleaning device.

In this embodiment, the cleaning device further includes a middle portion 3; the middle portion 3 is provided with a second connecting portion 32; the supporting portion 2 is provided with a third connecting portion 23; and the second connecting portion 32 is detachably connected to the third connecting portion 23 to detachably connect the middle portion 3 to the supporting portion 2. The second connecting portion 32 is rotatably connected to the third connecting portion 23. The third connecting portion 23 is a convex point; the second connecting portion 32 is provided with a sliding chute 321 and a rotating groove 322; and the convex point enters the rotating groove 322 from the sliding chute 321 to enable the convex point to rotate inside the rotating groove 322, so that the middle portion 3 rotates relative to the supporting portion 2. By use of the design of the convex point and the rotating groove 322, a user can rotate the cleaning device to make a first air pipe 42 aligned with different directions to meet needs of various usage scenarios. Due to the design of the sliding chute 321, the user can remove the middle portion 3 and the supporting portion 2, which facilitates storage.

In this embodiment, a tie 111 is arranged at the first opening 11; the supporting portion 2 is provided with a clamping slot 21; the supporting portion 2 passes through the second opening 12 and the first opening 11 in sequence; and the tie 111 is tightly tied inside the clamping slot 21 to connect the connecting bag 1 to the supporting portion 2. The connecting bag body 1 can be connected to the clamping slot 21 through the tie 111, so that the structure is simple, and the cost is reduced.

In this embodiment, the cleaning device further includes an extending portion 4, and the extending portion 4 is detachably connected to the middle portion 3. The extending portion 4 includes a middle pipe 41 and a first air pipe 42; the middle pipe 41 is detachably connected to the first air pipe 42; and the middle pipe 41 is detachably connected to the middle portion 3. The extending portion 4 can be removed from the middle portion 3 to facilitate the storage. Meanwhile, the middle pipe 41 can be removed from the first air pipe 42, which facilitates the storage, and different types of first air pipes 42 can also be replaced. It is convenient to meet use requirements of the user in different scenarios.

In this embodiment, the middle pipe 41 includes several detachable connecting pipes, and the several detachable connecting pipes are detachably connected to each other to form a whole. The middle pipe 41 at least includes a first connecting pipe 411, a second connecting pipe 412, and a third connecting pipe 413. The middle pipe 41 is formed by mounting at least three connecting pipes in this embodiment, and the user can eliminate or add more connecting pipes according to different length requirements, which facilitates use. Meanwhile, the connecting pipes are removable, which facilitates the storage.

In this embodiment, one end of the middle portion 3 is provided with a fourth connecting portion 414; one end of the first connecting pipe 411 is provided with a fifth connecting portion 415; the fourth connecting portion 414 is detachably connected to the fifth connecting portion 415 to detachably connect the middle portion 3 to the first connecting pipe 411; the other end of the first connecting pipe 411 is provided with a sixth connecting portion 416; one end of the second connecting pipe 412 is provided with a seventh connecting portion 417; the sixth connecting portion 416 is detachably connected to the seventh connecting portion 417 to detachably connect the first connecting pipe 411 to the second connecting pipe 412; the other end of the second connecting pipe 412 is provided with an eighth connecting portion 418, and one end of the third connecting pipe 413 is provided with a ninth connecting portion 419; the eighth connecting portion 418 is detachably connected to the ninth connecting portion 419 to detachably connect the second connecting pipe 412 to the third connecting pipe 413; the other end of the third connecting pipe 413 is provided with a tenth connecting portion 4110, and one end of the first air pipe 42 is provided with an eleventh connecting portion 4111; and the tenth connecting portion 4110 is detachably connected to the eleventh connecting portion 4111 to detachably connect the third connecting pipe 413 to the first air pipe 42. The fourth connecting portion 414, the sixth connecting portion 416, the eighth connecting portion 418, and the tenth connecting portion 4110 are internal threads, and the fifth connecting portion 415, the seventh connecting portion 417, the ninth connecting portion 419, and the eleventh connecting portion 4111 are external threads. External and internal threads are designed between the connecting pipes, between the connecting pipes and the middle portion 3, and between the connecting pipes and the first air pipe 42. This is convenient for removal. The components are firm after being mounted and are convenient to use.

In this embodiment, the supporting portion 2 includes several supporting claws 24; each of the supporting claws 24 includes an outer surface 241 and an inner surface 242 opposite to the outer surface 241; and the supporting claws 24 are connected to the connecting bag 1 through the outer surface 241 to support the connecting bag 1. A protective layer 19 is arranged inside the connecting bag 1, and the protective layer 19 is configured to cover the inner surface 242. Through the above structure, it is possible to avoid a situation where the supporting claws 24 press against a pipeline of the blowing and suction device.

In this embodiment, the other end of the first air pipe 42 is provided with a first air port 421. The first air pipe 42 is designed in an angle with the middle pipe 41. Or, the first air pipe 42 and the middle pipe 41 are coaxially arranged. The first air pipe 42 can have multiple styles to meet the use requirements in different scenarios.

In this embodiment, several antiskid lines 5 are uniformly distributed on side walls of the middle portion 3 and the middle pipe 41. Due to the design of the antiskid lines 5, the user can hold the cleaning device more stably during use of the cleaning device.

One or more implementation modes are provided above in combination with specific contents, and it is not deemed that the specific implementation of the present disclosure is limited to these specifications. Any technical deductions or replacements approximate or similar to the method and structure of the present disclosure or made under the concept of the present disclosure shall fall within the scope of protection of the present disclosure.

What is claimed is:

1. A cleaning device, comprising:
a connecting bag, wherein the connecting bag comprises a first opening and a second opening, and the first opening is communicated to the second opening; and
a supporting portion, wherein the supporting portion is connected to the connecting bag to support the connecting bag.

2. The cleaning device according to claim 1, wherein the supporting portion is an elastic supporting portion, and the connecting bag is a flexible connecting bag.

3. The cleaning device according to claim 1, wherein a radius of the first opening is less than a radius of the second opening; the supporting portion is connected to the first opening; and the second opening is configured to be connected to a blowing and suction device.

4. The cleaning device according to claim 3, wherein the connecting bag comprises a bag part and a locking part; the locking part is connected to the bag part; and the locking part is configured to connect the bag part to the blowing and suction device.

5. The cleaning device according to claim 4, wherein the locking part comprises a ring band; one side of the bag part is provided with several first connecting portions; and the ring band passes through the first connecting portions and is fixed to the bag part.

6. The cleaning device according to claim 5, wherein the locking part further comprises an elastic adjustment buckle; the ring band is connected to the elastic adjustment buckle; the ring band is arranged around the second opening; and the elastic adjustment buckle is configured to adjust a size of the second opening.

7. The cleaning device according to claim 1, further comprising a middle portion, wherein the middle portion is provided with a second connecting portion; the supporting portion is provided with a third connecting portion; and the second connecting portion is detachably connected to the third connecting portion to detachably connect the middle portion to the supporting portion.

8. The cleaning device according to claim 7, wherein the second connecting portion is rotatably connected to the third connecting portion.

9. The cleaning device according to claim 7, wherein the third connecting portion is a convex point; the second connecting portion is provided with a sliding chute and a rotating groove; and the convex point enters the rotating groove from the sliding chute to enable the convex point to rotate inside the rotating groove, so that the middle portion rotates relative to the supporting portion.

10. The cleaning device according to claim 1, wherein a tie is arranged at the first opening; the supporting portion is provided with a clamping slot; the supporting portion passes through the second opening and the first opening in sequence; and the tie is tightly tied inside the clamping slot to connect the connecting bag to the supporting portion.

11. The cleaning device according to claim 7, further comprising an extending portion, wherein the extending portion is detachably connected to the middle portion.

12. The cleaning device according to claim 11, wherein the extending portion comprises a middle pipe and a first air pipe; the middle pipe is detachably connected to the first air pipe; and the middle pipe is detachably connected to the middle portion.

13. The cleaning device according to claim 12, wherein the middle pipe comprises several detachable connecting pipes, and the several detachable connecting pipes are detachably connected to each other to form a whole.

14. The cleaning device according to claim 12, wherein the middle pipe at least comprises a first connecting pipe, a second connecting pipe, and a third connecting pipe.

15. The cleaning device according to claim 14, wherein one end of the middle portion is provided with a fourth connecting portion; one end of the first connecting pipe is provided with a fifth connecting portion; the fourth connecting portion is detachably connected to the fifth connecting portion to detachably connect the middle portion to the first connecting pipe; the other end of the first connecting pipe is provided with a sixth connecting portion; one end of the second connecting pipe is provided with a seventh connecting portion; the sixth connecting portion is detachably connected to the seventh connecting portion to detachably connect the first connecting pipe to the second connecting pipe; the other end of the second connecting pipe is provided with an eighth connecting portion, and one end of the third connecting pipe is provided with a ninth connecting portion; the eighth connecting portion is detachably connected to the ninth connecting portion to detachably connect the second connecting pipe to the third connecting pipe; the other end of the third connecting pipe is provided with a tenth connecting portion, and one end of the first air pipe is provided with an eleventh connecting portion; and the tenth connecting portion is detachably connected to the eleventh connecting portion to detachably connect the third connecting pipe to the first air pipe.

16. The cleaning device according to claim 15, wherein the fourth connecting portion, the sixth connecting portion, the eighth connecting portion, and the tenth connecting portion are internal threads, and the fifth connecting portion, the seventh connecting portion, the ninth connecting portion, and the eleventh connecting portion are external threads.

17. The cleaning device according to claim 1, wherein the supporting portion comprises several supporting claws; each of the supporting claws comprises an outer surface and an inner surface opposite to the outer surface; and the supporting claws are connected to the connecting bag through the outer surface to support the connecting bag.

18. The cleaning device according to claim 17, wherein a protective layer is arranged inside the connecting bag, and the protective layer is configured to cover the inner surface.

19. The cleaning device according to claim 12, wherein the other end of the first air pipe is provided with a first air port.

20. The cleaning device according to claim 12, wherein the first air pipe is designed in an angle with the middle pipe.
